(19) United States
(12) Patent Application Publication
(10) Pub. No.: US 2014/0322411 A1
(43) Pub. Date: Oct. 30, 2014

(54) ELECTRICAL MACHINE FOR EXTRACTING LIQUIDS AND METHOD OF USE THEREOF

(71) Applicant: SAMMIC, S.L., Azkoitia (ES)

(72) Inventors: AITOR GOGORZA SEGUROLA, AZPEITIA (Guipuzcoa) (ES); GORKA AGIRREZABAL OTEIZA, AZPEITIA (Guipuzcoa) (ES)

(73) Assignee: SAMMIC, S.L., Azkoitia (ES)

(21) Appl. No.: 14/328,190

(22) Filed: Jul. 10, 2014

Related U.S. Application Data
(63) Continuation-in-part of application No. 14/200,869, filed on Mar. 7, 2014.

(30) Foreign Application Priority Data
Mar. 7, 2013 (ES) 201300207
Jul. 10, 2013 (ES) 201300649

(51) Int. Cl. A47J 19/00; A23L 1/015

(52) U.S. Cl. CPC A47J 19/00; A23L 1/015
USPC 426/443; 34/108

(57) ABSTRACT

The present invention is an electric liquid extractor machine that is designed to carry out operations such as centrifuging, draining or extracting of liquids and a method of use thereof. The basic structure of the machine is comprised of a rigid assembly including at least one body and an interior base, a movable assembly including at least one motor element, a drive shaft and a perforated basket, and a movable cover for the passage of products to the interior of the machine. The union between the rigid assembly and the movable assembly is done by means of anti-vibration or flexible anchors. The machine may also include vibration sensors to detect the vibrations of the machine, and an emergency brake that may be activated should the vibrations exceed some predetermined safety threshold level. The present invention also includes a method of use of a machine of the aforementioned type.

This application claims priority to U.S. application Ser. No. 14/200,869 filed on Mar. 7, 2014, which claims priority to Spanish Application Number ES201300207 filed on Mar. 7, 2013. This application further claims priority to Spanish Application Number ES201300649 filed on Jul. 10, 2013.

### FIELD OF THE INVENTION

The present invention refers to an electric liquid extractor machine, and method of use thereof, for application in the industrial sector dedicated to the manufacturing and/or installation of food processing machines. The disclosed machine is capable of conducting different operations such as centrifuging, draining, and/or extracting liquids, for example, water, oils, and sauces; operations that are normal in any type of kitchen, both industrial and domestic. More precisely, the electric liquid extractor machine disclosed herein is of the type that includes a basket for inserting a food product therein, and is capable of working at different spinning speeds, depending on the needs of each type of product.

### BACKGROUND

In the current state of the art there are many distinct apparatuses and machines that carry out operations related to centrifuging, draining, and/or extracting liquids from greens, vegetables, and other foods (hereinafter referred to collectively as the “food products”). In general these machines are known to consist basically of a body, the interior of which has two areas separated by an interior base. One of these areas is where the motor means is housed. The motor means may consist of an electric motor, which is attached to a drive shaft that emerges vertically through the interior base. Attached to the end of the drive shaft opposite the motor means is a perforated basket in which the food products are placed. When this known machine is started up, the perforated basket begins to rotate and, due to the centrifugal force, the liquid present in the products is moved towards the exterior of the perforated basket, passed through its orifices, and falls down towards the interior base and is channelled towards the exterior of the machine.

One of the most significant problems with known machines is that the manual placement of the products in the perforated basket can provoke a shift in the center of gravity of the perforated basket assembly with respect to the drive shaft, which provokes vibration in the machine. To limit these problematic vibrations, the conventional options are to reduce the rotation speed and/or fix the machine to the ground. However, by limiting the rotation speed it can be difficult, if not impossible, to adapt the speed of the machine to the type of products as needed. Further, fixing the machine in place results in extremely limited functionality when handling the machine as its location cannot be easily changed.

An objective of the present invention is to substantially improve the operating and functional possibilities offered by known machines. The machine disclosed herein is designed for applying a range of differing speeds depending on and adapting itself to the products and the external conditions, while at the same time reducing the vibrating and shaking of the machine. Similarly, an objective of the method disclosed herein for extracting liquids from foods is to substantially improve the conventional methods and detect and control the load balance during operation of an electric liquid extractor machine.

### SUMMARY OF THE INVENTION

The present invention is a machine for extracting liquids from food products. The machine is capable of operating at variable rotation speeds and constructed to promote vibration absorption. The machine of the present invention enables an optimal draining of the products and of the amount of product introduced by means of selecting a suitable work program by incorporating means and devices especially designed in order to: 1) provide means for quickly and easily attaching and detaching the perforated basket; 2) detect the load distribution of the perforated basket and/or vibration in the machine and adjust the operating condition and motor speed automatically; 3) reduce the vibration and shaking of the machine, even at operating speeds that are higher than those employed by models currently on the market, and 4) immediately and automatically stop the machine when the dynamic cycle parameters, such as the vibration of the machine, exceeds preset safety values.

The structure of the machine of the invention is comprised of a rigid assembly (comprised of at least a body and an interior base) and a movable assembly (comprised of at least one motor element, a drive shaft and a perforated basket coupled to said drive shaft). The movable assembly is joined to the rigid assembly by means of anti-vibration or flexible anchors. The machine is equipped on its top portion with a movable cover through which the products can be introduced and extracted.

In one embodiment, the movable assembly is joined to the rigid assembly by means of said anti-vibration or flexible anchors attached to both the interior base and the motor element, which enables the movable assembly to have a certain degree of vertical, horizontal or rotational shift with respect of the rigid assembly, as well as of the rotational spin of the machine itself, which favours its improved operating.

To allow the movable assembly to vertically, horizontally or rotationally shift (independently of the real rotational spin of the machine) with respect to the rigid assembly it is necessary for there to be a gap between both assemblies to allow for such movement. The gap between the rigid assembly and the movable assembly could cause a loss of waterproofing which would affect components such as the motor element. In order to avoid said problem, the interior base is equipped with a neck and the drive shaft incorporates an umbrella that covers said neck of the interior base. Alternatively, the gap could be spanned by an element that allows said movements, such as a flexible, waterproof material. The machine is also equipped with a cover that has a lid and a latch which is positioned over the motor element to protect it.

In order to facilitate the use of the machine for liquid extraction, it is designed in such a way that said liquids can be channelled in order to avoid the possibility of damaging the components of the machine. For example, the interior base may have some curved surfaces that help collect the liquids and direct them towards an output orifice for the purpose of being evacuated.

For its part, the perforated basket incorporates in the center of its base a conically shaped guide and a series of notches arranged in a circular formation. The conical guide of the basket facilitates its placement onto the drive shaft. Radial pins arranged on the drive shaft are inserted into the notches on the base of the basket, which interlocks the basket and drive shaft and also transmits the drive shaft rotation to the perforated basket.

In certain cases, during the mounting of the perforated basket on the drive shaft, the notches of the basket remain misaligned with and therefore above the drive shaft pins. To avoid this, each time the machine is started up, the drive shaft rotates a few times and brusquely stops, which causes the basket to rotate and shift downwards upon alignment of the notches and the radial pins of the drive shaft. This facilitates a quick placement of the perforated basket. To remove the basket from the machine, it suffices to lift the basket vertically from the machine. In other words, the perforated basket is easily removable.

Furthermore, the machine is also equipped with a control and regulation unit for receiving and processing measurements of the off-centering of the load or the vibration of the machine. Such measurements may be accomplished, for example, by including vibration sensors, typically accelerometers. The information provided by these accelerometers is transmitted to the control and regulation unit of the machine, which determines the parameters of the work cycle and can even can stop the operation of the machine if the vibration is excessive, alerting the user to redistribute the food products. This enables the machine to operation under different circumstances.

The machine is likewise equipped with diverse security devices for guaranteeing the user a very safe operability. For example, the machine can detect whether the cover is open or closed by means of position or presence sensors, in such a way that the machine can only be started up when the cover is in the closed position. Moreover, if during the work cycle the vibration measuring devices detect that the vibrations are exceeding certain limits considered to be safe for correct maintenance of the mechanical components of the machine, an emergency brake system is automatically activated, which is able to completely stop the machine in a few seconds. This emergency brake system is also activated if for any reason the cover opens while the machine is operating.

The following is a description of the invention based on a manner of embodiment of the same and with reference to the attached figures, as folllows:

### DESCRIPTION OF THE DRAWINGS

FIG. 1: An perspective view of the machine of the invention.

FIG. 2: A cross-sectional view of the machine of FIG. 1.

FIG. 3: A bottom perspective view of the interior base, motor, and mounting elements.

FIG. 4: A top perspective view of the base of the perforated basket and the drive shaft.

FIG. 5: A bottom perspective view of the base of the perforated basket.

FIG. 6: A diagram of a method of use of the machine disclosed herein.

In the present description, terms such as vertical, horizontal, top or bottom, above or below, or others having an equivalent nature are expressed in accordance with the normal operating position of the machine. In the figures the reference numbers designate equal or equivalent parts.

### DETAILED DESCRIPTION

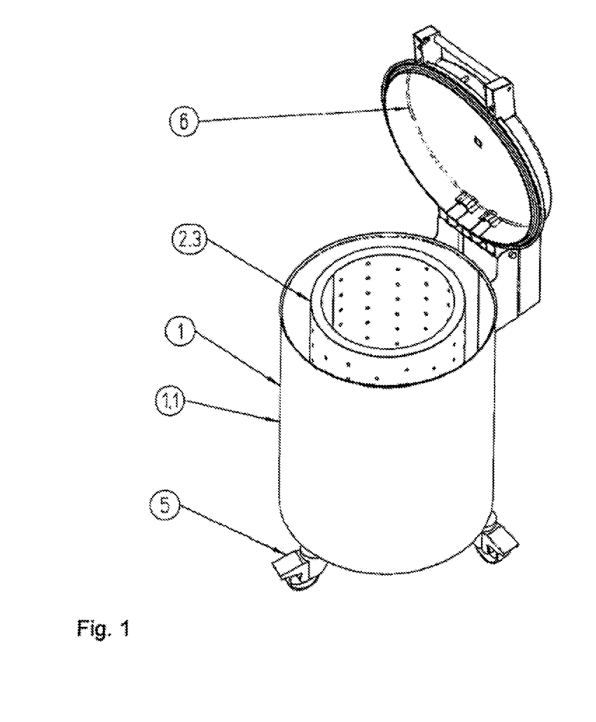

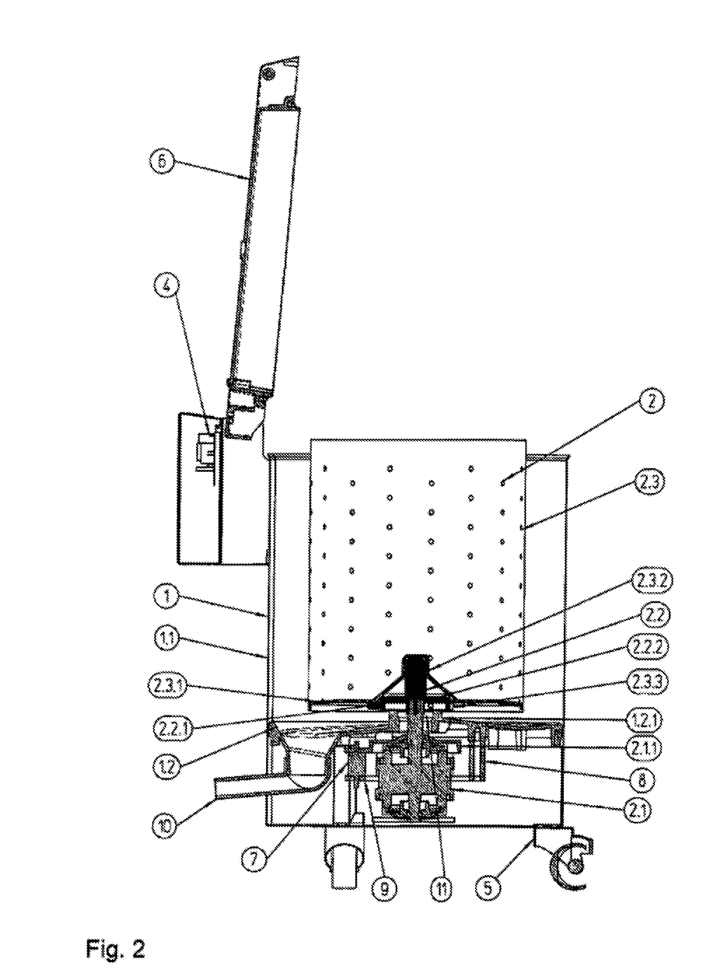

The electric machine for extracting liquids disclosed herein is comprised of a rigid assembly (1) and a movable assembly (2). From FIGS. 1 and 2 it can be seen that the rigid assembly (1) is comprised of a body (1.1) and an interior base (1.2). The movable assembly (2) is comprised of a motor element (2.1), drive shaft (2.2) and perforated basket (2.3).

As can be seen in FIG. 1, the body (1.1) of the rigid assembly (1) is of a rigid nature, and may be supported by wheels (5), legs, or a base. The body (1.1) incorporates a movable cover (6), which may be opened (if attached to the machine) or removed to insert food products into the perforated basket (2.3). The perforated basket (2.3) is positioned inside body (1.1). In the embodiment shown, the cover (6) is joined to the body (1.1) by means of a hinge.

The rigid assembly (1) is joined to the movable assembly (2) by means of anti-vibration or flexible anchors (7). In the embodiment shown in FIG. 2 the rigid assembly (1) is joined to the motor element (2.1). As is shown, the interior base (1.2) has cylinders (8) coupled to it and said cylinders (8) are also attached to a support ring (9). The anti-vibration or flexible anchors (7), to which the motor element (2.1) is fixed, are also fixed to the support ring (9).

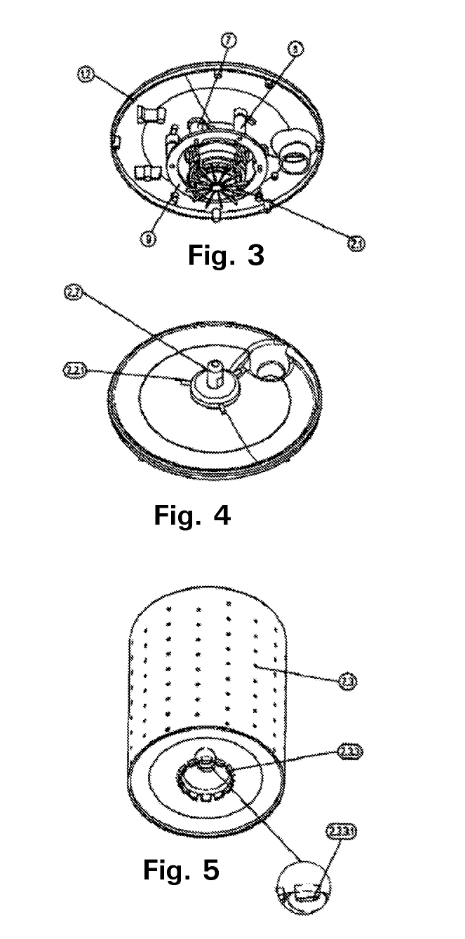

FIG. 3A displays this assembly in an isometric manner. In this embodiment the anti-vibration or flexible anchors (7) remain in the compressed state. Obviously the mounting of the anti-vibration or flexible anchors (7) can be done in different ways, arranged in such a way that they remain in tension or compression. For example, to leave the anchors (7) in tension, it would be sufficient to use them to fix the motor element (2.1) directly to the interior base (1.2). Likewise, the union between the rigid assembly (1) and the movable assembly (2) can be between different elements, for example joining the motor element (2.1) to a base at the bottom portion of the machine (not represented in the figures) by means of anti-vibration or flexible anchors (7).

The union between rigid assembly (1) and movable assembly (2) through the anti-vibration or flexible anchors (7) enables the movable assembly (2) a certain degree of vertical, horizontal or rotational shift (independently of the real rotational spin of the machines) with respect of rigid assembly (1), causing an gyroscopic effect and reducing the vibrations that are created by centrifugal forces in the machine.

The machine furthermore is equipped with a control and regulating unit (4) that receives information from the vibration sensors, such as accelerometers (not shown). Depending upon the readings from the vibration sensors, the control and regulation unit may adjust the operating speed of the motor. In the event the vibrations exceed a predetermined safety limit considered as safe, the control unit (4) automatically activates an emergency brake system capable of completely stopping the machine in a few seconds. Additionally, the machine may be equipped with audio and/or visual signals that may be activated by the control and regulation unit simultaneously with activation of the emergency brake when the vibrations exceed a predetermined safety limit considered as safe, thereby alerting the user that the load must be redistributed within the perforated basket (2.3).

As can be seen in FIGS. 2, 4A and 4B, the perforated basket (2.3) is removable. The perforated basked (2.3) is capable of being mechanically interlocked with the drive shaft (2.2). Such interlocking may be accomplished by the inclusion of compatibly sized indentions and protrusions on the base (2.3.1) of the perforated basked (2.3) and the drive shaft (2.2). In a preferred embodiment, the base (2.3.1) of the perforated basket (2.3) has a conical guide (2.3.2) in the center thereof and a series of notches in a circular formation (2.3.3). The conical guide (2.3.2) assists in positioning the perforated basket (2.3) on the drive shaft (2.2). Radial pins (2.2.1) on the drive shaft (2.2) are introduced into the notches (2.3.3) of the perforated basket, which interlocks the drive shaft (2.2) and the perforated basket (2.3) and allows for the transmission of the rotation of drive shaft (2.2) to the perforated basket (2.3).

When mounting the perforated basket (2.3), in order to ensure that the notches (2.3.3.) of the perforated basket (2.3) are interlocked with the radial pins (2.2.1) of drive shaft (2.2), every time the machine starts up, the drive shaft (2.2) rotates a few times and then brusquely stops. This causes the basket (2.3) to rotate and shift downwards, leaving the radial pins (2.2.1) in the notches (2.3.3) of the perforated basket (2.3). This facilitates the correct positioning of the basket (2.3) and promotes a balanced distribution of the load housed within the basket (2.3).

As has been stated above, the movable assembly (2) is permitted to shift vertically, horizontally or by spinning (independently of the real rotational spin of the machines) with respect of rigid assembly (1), and the liquid channelling system is designed to correspond to this circumstance. In the machines of the known art, the liquid extracted from the products falls into interior base (1.2) and from there it is channelled by means of a tube outside the machine.

In one embodiment of the machine of the invention, there is a gap (11) between the drive shaft (2.2) and the interior base (1.2) to permit the spinning (independently of the rotational spin) and/or shifting of drive shaft (2.2) with respect of interior base (1.2). As a result, waterproofing elements are necessary between the drive shaft (2.2) and the interior base (1.2). Such waterproofing elements include a neck (1.2.1) installed on the interior base (1.2), and an umbrella attached (2.2.2) to the drive shaft (2.2). The machine is also equipped with a cover that has a lid and a latch (2.1.1) which is positioned over the motor element (2.1) to protect it.

In an alternate embodiment, the gap (11) between the drive shaft (2.2) and the interior base (1.2) is spanned by an element, such as a flexible, water-proof material, that enables the movement of the drive shaft (2.2).

As has been stated, optionally there is a union between the movable assembly (2) and the rigid assembly (1) that may be installed in such a way that the anti-vibration or flexible anchors (7) are left in the tension or compression state when the machine is stopped. Likewise the union of the movable assembly (2) can be to the interior base (1.2) or other components of the rigid assembly (1), or components attached thereto. Under these conditions and by increasing the rotation speed, the desired gyroscopic effect is created and the parasitical moments associated with the off centring of the load on the drive shaft tend to be minimised.

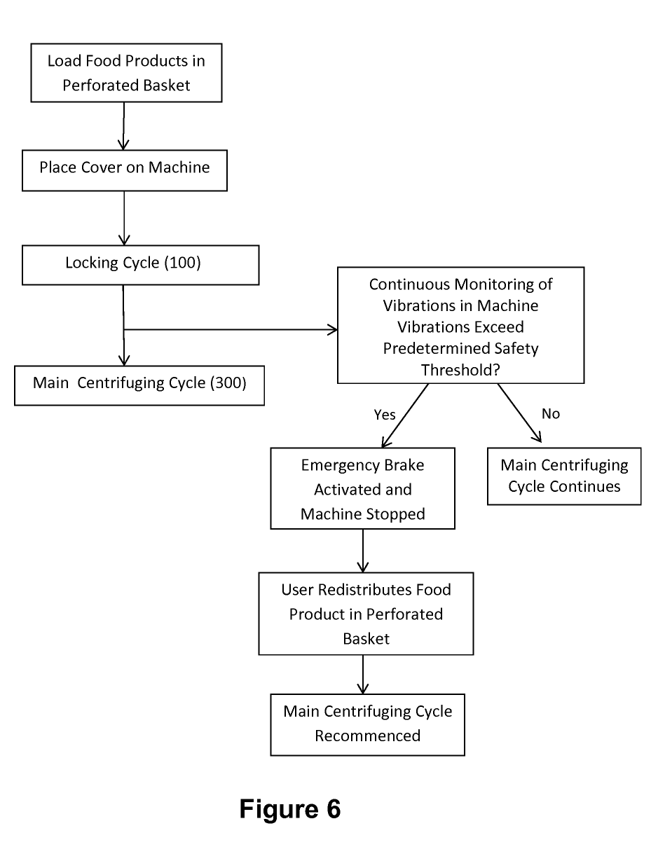

The present invention is also a method for extracting liquids from food products (see FIG. 6). Said method includes selecting an electric liquid extraction machine of the type disclosed above. First, the food products to be processed are placed in the perforated basked (2.3). The cover (6) is then moved into the closed position. A locking stage (100) is then commenced wherein the drive shaft revolves for a short period of time and then comes to a sudden stop. This locking stage (100) is designed to ensure the correct position of the perforated basked (2.3) on the drive shaft (2.2). Upon completion of the locking stage, a load distribution verification stage (200) may be commenced. During the load distribution verification cycle (200), the machine operates at relatively low speed for a short period of time, at the end of which the load distribution is measured using the vibration sensors. If, at the end of the load distribution verification cycle (200), the load distribution is unbalanced, the machine stops indicating to the user that the load must be redistributed in the perforated basked (2.3). If, at the end of the load distribution verification stage (200), the load distribution is balanced, the main centrifuging cycle (300) is commenced. Alternatively, the main centrifuging cycle (300) may be commenced immediately following completion of the locking stage (100). The operating parameters of the machine during the main centrifuging cycle (300) are dependent upon the type of food to be processed.

During the locking stage (100), the load distribution verification cycle (200), and the main centrifuging cycle (300) the balance of the load is monitored by vibration sensors. Depending upon the measurements from the vibration sensors, the operating speed of the machine may be adjusted. In the instance that the measurements exceed the threshold for a predetermined safety condition, the emergency brake is activated and the machine is stopped, indicating to the user that the load must be redistributed. Upon redistribution of the load, the operation of the machine is restarted and the interrupted cycle is completed.

The following are illustrative examples of applications of the aforementioned method:

### Example 1

### Centrifuging Heavy Products At Slow Speed

Type of product: carrots, beans, potato and the like.

Rotation speed: 350 rpm.

After completion of the loading the product, the machine completed the locking stage (100) whereby the drive shaft completes a few revolutions followed by a sudden stop to ensure that the perforated basket (2.3) is correctly positioned and initially distribute the load. The machine then commences the main centrifuging cycle (300), reaching the speed of 350 rpm and running until the cycle time is completed, then stopping automatically. During this process, the balance of the load and vibrations in the machine are continuously monitored by the system of vibration sensors, and, depending upon the readings from the vibration sensors the operating speed of the motor may be adjusted. In case of excessive vibration, the emergency braking system stops the machine completely and emits an acoustic and/or visual signal indicating “load unbalanced”.

### Example 2

### Centrifuging Light Products at Fast Speed

Type of product: lettuce, chard, escarole and the like.

Rotation speed: 900 rpm.

After loading the food product into the perforated basked (2.3), the machine commences a locking stage (100) wherein the drive shaft completes a few revolutions followed by a sudden stop to ensure that the basket is correctly positioned and initially distribute the load. The machine then starts again, commencing a load distribution verification stage (200), operating first at a slower speed (under 250 rpm) and controlling the load balance for approximately 6 seconds. If at the end of the load distribution verification stage (200) the load is unbalanced, the machine stops and emits an acoustic and/or visual signal indicating “load unbalanced”. In this case the basket must be shaken to redistribute the load and start again. If the load balance is correct, the machine stops and immediately commences the main centrifuging cycle (300) at the maximum speed of 900 rpm, running until the cycle time is completed and then stopping automatically. During this process, the balance of the load and vibrations in the machine are continuously monitored by the system of vibration sensors, and, depending upon the readings from the vibration sensors the operating speed of the motor may be adjusted. In case of excessive vibration, the emergency braking system stops the machine completely and emits an acoustic and/or visual signal indicating “load unbalanced”.

The above is a detailed description of particular embodiments of the invention. It is recognized that departures from the disclosed embodiments may be made within the scope of the invention and that obvious modifications will occur to a person skilled in the art. Those of skill in the art should, in light of the present disclosure, appreciate that many changes can be made in the specific embodiments which are disclosed herein and still obtain a like or similar result without departing from the spirit and scope of the invention. All of the embodiments disclosed and claimed herein can be made and executed without undue experimentation in light of the present disclosure.

1. An electric liquid extractor machine comprised of:
a movable assembly comprised of a motor, a drive shaft, and a perforated basket;
a rigid assembly comprised of a body and an interior base, wherein the body has an open top, a closed bottom, and an interior that is separated into two areas by an interior base;
a removable cover sized to accommodate the open top of the body; and, anti-vibration anchors, wherein the rigid assembly and the movable assembly are connected by the anti-vibration anchors;
the motor and perforated basket are located in the interior of the body, on opposite sides of the interior base, and are connected by the drive shaft which passes through an opening in the interior base.

2. The liquid extractor machine of claim 1 wherein the opening in the interior base is sized to create a gap between the interior base and the drive shaft which passes through it.

3. The liquid extractor machine of claim 2 wherein the gap between the interior base and the drive shaft is spanned by a flexible, waterproof material.

4. The liquid extractor machine of claim 2 wherein the interior base of the rigid assembly includes a neck which protrudes from the surface thereof and the drive shaft of the movable assembly includes an umbrella.

5. The electric liquid extractor machine of claim 2 wherein the perforated basket is removably connected to the drive shaft.

6. The electric liquid extractor machine of claim 5 wherein the perforated basket and drive shaft are mechanically interlocked.

7. The electric liquid extractor machine of claim 6 wherein the perforated basket is further comprised of a base with a conical guide, wherein the base also includes indentions made therein, and the drive shaft is further comprised of protrusions extending therefrom, wherein the indentions are sized to accommodate the protrusions extending from the drive shaft.

8. The electric liquid extractor machine of claim 2 wherein the perforated basket includes a conical guide on its base as well a series of notches arranged in a circular formation and the drive shaft includes radial pins which are sized and positioned to be accepted by the notches of the perforated basket.

9. The electric liquid extractor machine of claim 2 wherein the body is composed of a rigid material and is supported on a set of wheels.

10. The electric liquid extractor machine of claim 2 wherein the motor has a cover which is incorporates a lid and a latch.

11. The electric liquid extractor machine of claim 1 further comprised of:
vibration sensors;
a control and regulation unit; and, an emergency brake;
wherein the control and regulation unit receives and processes information from the vibration sensors regarding the vibration of the machine and based upon the measurements adjusts the operating speed of the motor;
alternatively, if the vibration exceeds a predetermined threshold level, the control and regulation unit activates the emergency brake.

12. The electric liquid extractor machine of claim 11 further comprised of an acoustic signal wherein if the vibration exceeds a predetermined threshold level, the control and regulation unit activates the acoustic signal.

13. The electric liquid extractor machine of claim 11 further comprised of a visual signal wherein if the vibration exceeds a predetermined threshold level, the control and regulation unit activates the visual signal.

14. The electric liquid extractor machine of claim 11 further comprised of acoustic and visual signals wherein if the vibration exceeds a predetermined threshold level, the control and regulation unit activates the acoustic and visual signals.

15. An electric liquid extractor machine comprised of:
a movable assembly comprised of a motor, a drive shaft, and a perforated basket;
a rigid assembly comprised of a body and an interior base, wherein the body has an open top, a closed bottom, and an interior that is separated into two areas by an interior base;
a movable cover sized to accommodate the open top of the body;
wherein the motor and perforated basket are located in the interior of the body, on opposite sides of the interior base, and are connected by the drive shaft which passes through an opening in the interior base;
vibration sensors;
a control and regulation unit; and
an emergency brake;
wherein the control and regulation unit receives and processes information from the vibration sensors regarding the vibration of the machine and based upon the measurements adjusts the operating speed of the motor;
alternatively, if the vibration exceeds a predetermined threshold level, the control and regulation unit activates the emergency brake.

16. The electric liquid extractor machine of claim 15 further comprised of acoustic and visual signals wherein if the vibration exceeds a predetermined threshold level, the control and regulation unit activates the acoustic and visual signals.

17. A method for extracting liquids from food comprised of:
selecting an electric liquid extractor machine comprised of:
a movable assembly comprised of a motor, a drive shaft, and a perforated basket;
a rigid assembly comprised of a body and an interior base, wherein the body has an open top, a closed bottom, and an interior that is separated into two areas by an interior base;
a cover sized to accommodate the open top of the body;
wherein the motor and perforated basket are located in the interior of the body, on opposite sides of the interior base, and are connected by the drive shaft which passes through an opening in the interior base;
vibration sensors;
a control and regulation unit; and
an emergency brake;
wherein the control and regulation unit receives and processes information from the vibration sensors regarding the vibration of the machine;
loading the food to be processed into the perforated basket;
moving the cover into the closed position;
completing a locking cycle;
completing a main centrifuging cycle;
continuously monitoring the vibration during the locking cycle and the main centrifuging cycle;
activating the emergency brake and stopping the machine if the vibrations exceed exceeds a predetermined threshold level;
redistributing the load within the perforated basket;
restarting the machine to allow the interrupted cycle to complete.

18. The method of extracting liquids from foods of claim 17 wherein the electric liquid extractor machine selected is further comprised of acoustic and visual signals wherein if the vibration exceeds a predetermined threshold level, the control and regulation unit activates the acoustic and visual signals.

19. The method of extracting liquids from foods of claim 17 further comprised of adjusting the operating speed of the motor based upon the measurements received from the vibration sensors regarding the vibration of the machine.

20. The method of extracting liquids from foods of claim 17 wherein the electric liquid extractor machine selected is further comprised of anti-vibration anchors, wherein the rigid assembly and the movable assembly are connected by the anti-vibration anchors.

21. The method of extracting liquids from foods of claim 17 wherein a load distribution verification cycle is completed following the completion of the locking cycle.

22. The method of extracting liquids from foods of claim 21 wherein the electric liquid extractor machine selected is further comprised of further comprised of acoustic and visual signals wherein if the vibration exceeds a predetermined threshold level, the control and regulation unit activates the acoustic and visual signals.

23. The method of extracting liquids from foods of claim 21 wherein the electric liquid extractor machine selected is further comprised of anti-vibration anchors, wherein the rigid assembly and the movable assembly are connected by the anti-vibration anchors.
